(19) United States
(12) Patent Application Publication
(10) Pub. No.: US 2026/0131852 A1
(43) Pub. Date: May 14, 2026

(54) ELECTROMECHANICAL STEERING SYSTEM, METHOD FOR OPERATING SUCH A SYSTEM AND VEHICLE

(71) Applicant: AUDI AG, lngolstadt (DE)

(72) Inventors: Michael PATZELT, Pfaffenhofen (DE); Kahnt ANDREAS, Pliezhausen (DE)

(73) Assignee: AUDI AG, lngolstadt (DE)

(21) Appl. No.: 19/336,840

(22) Filed: Sep. 23, 2025

(30) Foreign Application Priority Data
Nov. 12, 2024 (DE) 102024133089.9

(51) Int. Cl. B62D 6/00; B62D 5/04

(52) U.S. Cl. CPC B62D 6/00; B62D 5/0406

(57) ABSTRACT

An electromechanical steering system with an assistance device for steering support, with a steering handle, with a steering angle sensor, with at least one steering axle, with an actuator, and with a steering control device to translate the detected steering angle into a wheel steering angle. The actuator sets the wheel steering angle predetermined by the steering control device, and the steering control device activates the assistance device which brings about a decoupling of the wheel steering angle from the steering angle of the steering handle in that the actuator changes the wheel steering angle independently of the steering angle of the steering angle sensor. The steering control device monitors operation of the steering handle while the assistance device is activated, and the decoupling of the wheel steering angle from the steering angle of the steering handle is released in several stages or continuously.

### FIELD

The invention relates to an electromechanical steering system, in particular an electromechanical steering system for two-track vehicles. Furthermore, the invention relates to a vehicle with such a steering system and a method for operating such an electromechanical steering system.

### BACKGROUND

Electromechanical steering systems, such as steer-by-wire systems, are mainly used to control two-track vehicles. In steer-by-wire steering systems, there is no mechanical connection between a steering handle and a steering gear. In this case, a complete electronic force and travel control of both the steering handle and the steered vehicle wheels is realized.

Modern assistance systems in vehicles can support the driver in various driving maneuvers or driving situations. For example, modern assistance systems can automatically keep the driver in lane, regulate and maintain the distance to a vehicle in front, or provide assistance in the event of an emergency braking maneuver. An assistance intervention by an assistance device therefore takes place in such emergency and dangerous situations.

Assistance systems have full control authority during a steering intervention and can already steer the vehicle in the event of misinterpretation before the driver can fully assess the situation. Such autonomous intervention by the assistance system can unsettle a driver. Especially when using steer-by-wire steering systems, the user lacks immediate feedback on the driving condition during the assistance intervention, since no torque is transmitted to the steering handle due to the lack of a mechanical connection to the wheel(s). In addition, the driver is not given any feedback about the trajectory recommended by the assistance system.

DE102023200693A1 describes an assistance system for autonomously moving a vehicle into an optimized dynamic driving state and a vehicle which is equipped with a system for controlling a vehicle by an assistance system for autonomously moving a vehicle into an optimized dynamic driving state. A system for controlling the vehicle is proposed herein, which interacts with the driver on request and adapts the vehicle control to the wishes and/or skills of the driver. At its core, this document aims to implement a database that records multiple drivers and executes interventions based on them. This allows driver behavior to be analyzed by an AI and stored in a database. Driver feedback is provided based on a deviation from the target value and this is saved. There is a risk that the database will learn incorrect behavior from the driver, but several drivers and driving modes are stored in this database, which are then provided as a data basis for the assistance intervention.

DE102021205110A1 describes a device and a method for controlling a vehicle during aquaplaning and a vehicle. The device is designed to provide a front axle signal for providing a front steering angle adapted to the aquaplaning condition in response to a detection signal representing an aquaplaning condition on the front axle of the vehicle, decoupled from a direction signal representing a desired change in the direction of travel of the vehicle.

DE102016217772A1 describes a device, an operating method and an electronic control device for controlling an at least partially automatically driving vehicle. The assistance device described therein can either decouple the steering angle position of the steering wheel with respect to the wheel angle position or (completely) couple it.

### SUMMARY

It is therefore the object of the present invention to provide an electromechanical steering system, a method for operating such a system and a vehicle with such a system, which contribute to an improved switching from an intervention of the assistance device to a user intervention.

The electromechanical steering system according to the invention comprises an assistance device for steering support, in particular in emergency or dangerous situations. However, it is also possible that the assistance device of the steering system according to the invention is used to support comfort functions or autonomous/semi-autonomous driving. Particularly in semi-autonomous driving, a faster handover between steering by the driver and steering by the assistance system can take place, wherein it is also possible to hold the steering wheel straight. The driver can regain control through the steering intervention as soon as she applies a steering torque or also exceeds a steering torque threshold. The assistance device of the steering system according to the invention can also be used in an autonomous parking function in which the steering wheel is positioned straight and the driver must be able to intervene in an emergency.

A steering handle, which is designed as a steering wheel, for example, is provided so that the user can specify the direction of travel. However, other types of steering handles are also possible, such as a joystick or individual buttons. In any case, the steering handle has a steering angle sensor, wherein the steering angle sensor is configured to detect a steering angle of the steering handle. Furthermore, the electromechanical steering system comprises at least one steering axle to which an actuator is assigned. A steering control device is provided which is configured to translate the detected steering angle into a wheel steering angle, wherein the actuator is caused by means of the steering control device to set the wheel steering angle specified by the steering control device, and wherein the steering control device is further configured to activate the assistance device, for example in an emergency or dangerous situation. Activating the assistance device results in at least a partial or complete decoupling of the wheel steering angle from the steering angle of the steering handle, as the actuator changes or adjusts the wheel steering angle independently of the steering angle of the steering angle sensor.

According to the invention, the steering control device is configured to monitor operation of the steering handle while the assistance device is activated, wherein the decoupling of the wheel steering angle from the steering angle of the steering handle is released in several stages or continuously when a) a predefined torque or a predefined temporal torque change is detected by a torque sensor associated with the steering handle, or when b) a predetermined temporal steering angle change is detected by the steering angle sensor.

In this way, a quick intervention by the driver is ensured based on the determined steering wheel torque or the determined steering angle change. This means that the intervention of the assistance device does not have to be interrupted or suspended, but can continue to be active in parallel with the user intervention, without patronizing or overruling the user in his or her directional decision. At the same time, the steering system according to the invention with the assistance device enables early defusing of emergency or dangerous situations by allowing—within predefined safety limits—wheel steering angles that represent a deviation from the steering angle of the steering handle (decoupling).

For example, a magnetoresistive element or several such elements are used as a torque sensor to detect the rotation of the steering wheel. Alternatively or additionally, one or more strain gauges are used to measure the strain caused by the applied torque. Alternatively or additionally, a complete measuring steering wheel can be used as a steering handle, which can determine not only the torque but also the rotation angle and the angular velocity.

The steering angle corresponds to the angular position detected by the steering angle sensor on the steering handle, for example the steering wheel. The wheel steering angle is the angular position of the wheels or their mounts.

The electromechanical steering system is preferably designed as a steering column-free steer-by-wire steering system, wherein—unlike in a power steering system—it cannot provide the user with direct haptic feedback about the driving condition due to mechanical coupling. Here it is all the more important that a multi-stage or continuous downgrading of the decoupling of the steering angle to the wheel steering angle takes place and that the user increasingly receives feedback about her increasing influence on the wheel angle position.

It has proven advantageous if the steering control device is configured to completely release the decoupling of the wheel steering angle from the steering angle when detecting the predefined torque or the predefined torque change at the steering handle. In this way, the assistance intervention of the assistance device can be reduced while at the same time allowing user intervention; in particular until the assistance function is completely terminated.

In order to prevent the user from immediately giving back control of the steering when an emergency or dangerous situation actually occurs, and to first wait for the time colloquially referred to as the “shock moment”, it is preferable if the steering control device is configured to monitor the operation of the steering handle only after a predetermined time interval has elapsed after the activation of the assistance device. For example, this time interval could last from 0.2 seconds to 3 seconds. However, the present invention is not limited to this time interval and other time intervals are also possible.

A smooth transition from assistance intervention back to full user control can be achieved by setting up the steering control device to reverse the decoupling of the wheel steering angle from the steering angle during a predefined time interval, so that during this time interval user intervention is also possible in parallel with the intervention of the assistance device. For example, this time interval could be five seconds or less. However, the present invention is not limited to this time interval and other time intervals are also possible.

In any case, the assistance intervention can be completely deactivated during the predefined time interval. It is possible to deactivate the assistance intervention linearly. However, in cases of misjudgments by the assistance device, an exponential deactivation of the assistance intervention can be carried out alternatively or additionally.

Alternatively or additionally, the assistance intervention can be completely deactivated over the predefined course of the acting torque (hand torque threshold on the steering handle). It is possible to deactivate the assistance intervention linearly. However, in cases of misjudgments by the assistance device, an exponential deactivation of the assistance intervention can be carried out alternatively or additionally. The strength of the assistance intervention can also be achieved using predefined torque levels.

The advantages, advantageous configurations and effects explained above in connection with the electromechanical steering system apply equally to the method according to the invention for operating such an electromechanical steering system.

The method according to the invention comprises the following steps:
activating an assistance device for steering support, for example when an emergency or dangerous situation is detected, wherein a wheel steering angle is decoupled from a steering angle of a steering handle and the wheel steering angle is changed or adjusted, at least partially, independently of the steering angle of a steering angle sensor of the steering handle (in this case, a faster vehicle reaction or an increased vehicle transverse offset within the first few seconds of an emergency maneuver is achieved by pre-controlling the axle, while at the same time maintaining control by the driver),
monitoring whether the steering handle is operated while the assistance system is activated, and
terminating the decoupling of the wheel steering angle from the steering angle of the steering handle in multiple stages or continuously,
if a) a predefined torque or a predefined temporal torque change is detected by a torque sensor associated with the steering handle,
or if b) a predetermined temporal change in the steering angle is detected by the steering angle sensor.

This also means that a method is provided, in which the intervention of the assistance device is not interrupted or completely suspended, but continues to be active in parallel with the user intervention, without patronizing or overruling the user in his or her directional decision.

In order to avoid the aforementioned “moment of shock”, it is advantageous if the operation of the steering handle is only monitored after a predetermined time interval has elapsed after the assistance device has been activated. However, it is preferred that within the specified time interval, manual intervention and deactivation of the assistance intervention is only permitted when a torque threshold is exceeded (purely by way of example at 3 Newton meters (N m)). In this way, within the specified time interval of the “moment of shock”, the manual torque threshold is increased compared to that in normal operation.

Alternatively or additionally, the assistance intervention can only be completely deactivated when a predefined torque is exceeded or over the predefined course of the acting torque (for example, when a torque threshold is reached). It is possible to deactivate the assistance intervention linearly. However, in cases of misjudgments by the assistance device, an exponential deactivation of the assistance intervention can be carried out alternatively or additionally. The strength of the assistance intervention can also be achieved using predefined torque levels.

Alternatively or additionally, it is preferred that the decoupling of the wheel steering angle from the steering angle is released during a predefined time interval, so that during this time interval a user intervention can also take place parallel to the intervention of the assistance device. This time interval can last from two seconds to ten seconds, for example. For example, the time interval is five seconds or less. However, the present invention is not limited to these time intervals, so that other time intervals are also possible.

In one variant, it is advantageous if the decoupling is reduced linearly during the predefined time interval. Alternatively, in another variant, the decoupling can be reduced exponentially during the predefined time interval.

The advantages, advantageous configurations and effects explained above in connection with the electromechanical steering system apply equally to the vehicle according to the invention, in particular a motor vehicle with such an electromechanical steering system.

The features and combinations of features mentioned above in the description as well as the features and feature combinations mentioned below in the description of the figures and/or merely shown in the FIGURE may be used not only in the combination specified, but also in other combinations or alone, without departing from the scope of the invention. The invention should therefore also be considered to comprise and disclose embodiments that are explicitly not shown or explained in the FIGURE, but emerge and can be provided from the explained embodiments by separate feature combinations.

### BRIEF DESCRIPTION OF THE FIGURES

Further advantages, features, and details of the invention result from the claims, the following description of preferred embodiments and on the basis of the drawing, in which:

FIG. 1 is a schematic representation of a vehicle with a steering system according to the invention.

### DETAILED DESCRIPTION

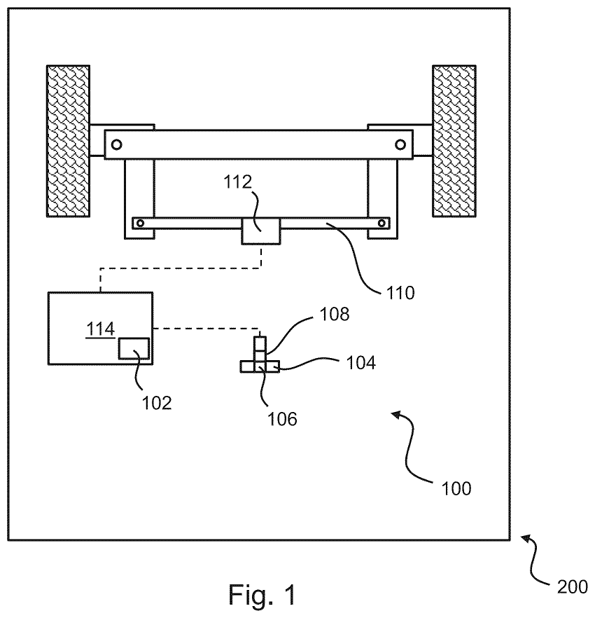

FIG. 1 shows a vehicle 200 with an electromechanical steering system 100, which in this case is designed as a steer-by-wire steering system. However, it is also possible for the steering system 100 to be used with a classic steering system with a steering column.

The electromechanical steering system 100 comprises a steering handle 104, for example a steering wheel, wherein a steering angle sensor 106 is associated with the steering handle 104. The steering angle sensor 106 is configured to detect a steering angle of the steering handle 104. In addition, the steering handle 104 is associated with a torque sensor 108 with which the torque introduced into the steering handle 104 by a user can be detected.

Furthermore, the electromechanical steering system 100 comprises a steering axle 110 and an actuator 112 associated with the steering axle 110.

The values of the steering angle sensor 106 and the torque sensor 108 are sent to a steering angle control device 114 for further processing. The steering control device 114 is configured such that it can translate the detected steering angle into a wheel steering angle, wherein the actuator 112 is caused by the steering control device 114 to adjust the wheel steering angle specified, and thus calculated, by the steering control device 114.

The electromechanical steering system 100 according to the invention is equipped with an assistance device 102 for steering support in emergency or dangerous situations. This assistance device 102 can be implemented as a function in the steering control device 114. In other words, the steering control device 114 is thus configured to activate the assistance device 102 in an emergency or dangerous situation. The detection of such a situation is based, for example, on a sensor-based, for example optical, evaluation of the roadway and/or the surroundings of the vehicle 200 and the steering system 100.

If an emergency or dangerous situation occurs, the assistance device 102 of the electromechanical assistance system 100 is activated. Activating the assistance device 102 then causes a decoupling of the wheel steering angle from the steering angle of the steering handle 104, in that the actuator 112 changes or adjusts the wheel steering angle independently of the steering angle of the steering angle sensor 106. In other words, the user is excluded from steering or changing the direction of travel—at least in a first step.

It could happen that the user recognizes that the detected emergency or dangerous situation is not one; thus, there is a misinterpretation of the situation by the assistance device 104, the steering control device 114 or even a higher-level control device.

For this reason and for such situations of misinterpretation, the steering control device 110 is configured to monitor operation of the steering handle 104 while the assistance device 102 is activated. However, the decoupling of the wheel steering angle from the steering angle of the steering handle 104 is released in several stages or continuously when a predefined torque or a predefined temporal torque change is detected by the torque sensor 108. Alternatively or additionally, the severity of the assistance intervention can also be reduced in several stages or continuously if a predetermined temporal change in the steering angle is detected by the steering angle sensor 106.

The decoupling of the wheel steering angle from the steering angle is completely released when the predefined torque or the predefined torque change at the steering handle 104 is detected, in particular over a predetermined time interval. In other words, the steering control device 114 is configured to bring back the decoupling of the wheel steering angle from the steering angle during a predefined time interval, so that during this time interval, user intervention is also possible in parallel with the intervention of the assistance device 102.

However, in order to prevent the user from intervening too suddenly, for example during the “moment of shock,” the steering control device 114 is here configured in such a way that the operation of the steering handle 104 is only monitored after a predetermined time interval has elapsed after the activation of the assistance device 102. Thus, the relationship between the steering angle and the wheel steering angle can only be restored after monitoring has begun. It is possible to deactivate the assistance intervention linearly. Alternatively, the assistance intervention can also be deactivated exponentially, for example to wait for the “moment of shock” mentioned above. However, it is preferred if the assistance intervention by the assistance device 102 is alternatively or additionally completely deactivated when a predefined torque threshold is reached or even over a predefined course of the torque acting on the steering handle 104. The strength of the assistance intervention can also be achieved using predefined torque levels.

The vehicle 200 equipped with the electromechanical steering system 100 explained above is therefore characterized by increased operational safety.

### LIST OF REFERENCE NUMERALS

100 steering system
102 assistance device
104 steering handle
106 steering angle sensor
108 torque sensor
110 steering axle
112 actuator
114 steering control device
200 vehicle

1. An electromechanical steering system with an assistance device for steering support,
with a steering handle,
with a steering angle sensor associated with the steering handle, wherein the steering angle sensor is configured to detect a steering angle of the steering handle,
with at least one steering axle,
with an actuator associated with the steering axle,
and with a steering control device which is configured to translate the detected steering angle into a wheel steering angle, wherein the actuator is caused by means of the steering control device to adjust the wheel steering angle specified by the steering control device,
and wherein the steering control device is further configured to activate the assistance device in the emergency or dangerous situation, wherein the activation of the assistance device causes an at least partial decoupling of the wheel steering angle from the steering angle of the steering handle by the actuator changing or adjusting the wheel steering angle independently of the steering angle of the steering angle sensor,
wherein the steering control device is configured to monitor operation of the steering handle while the assistance device is activated,
wherein the decoupling of the wheel steering angle from the steering angle of the steering handle is released in several stages or continuously if
a) a predefined torque or a predefined temporal torque change is detected by a torque sensor associated with the steering handle,
or
b) a predetermined temporal change in the steering angle is detected by the steering angle sensor.

2. The electromechanical steering system according to claim 1, wherein a steering column-free steer-by-wire steering system is present.

3. The electromechanical steering system according to claim 1, wherein the steering control device is configured to monitor the operation of the steering handle only after a predetermined time interval has elapsed after the activation of the assistance device.

4. The electromechanical steering system according to claim 1, wherein the steering control device is configured to reverse the decoupling of the wheel steering angle from the steering angle during a predefined time interval, so that during this time interval, parallel to the intervention of the assistance device, user intervention is also possible.

5. A method for operating an electromechanical steering system according to claim 1, comprising:
activating an assistance device for steering support, for example when detecting an emergency or dangerous situation, wherein a wheel steering angle is decoupled from a steering angle of a steering handle and, at least partially, the wheel steering angle is changed or adjusted independently of the steering angle of a steering angle sensor of the steering handle,
monitoring whether the steering handle is operated while the assistance system is activated, and
terminating the decoupling of the wheel steering angle from the steering angle of the steering handle in multiple stages or continuously,
if a) a predefined torque or a predefined temporal torque change is detected by a torque sensor associated with the steering handle,
or if b) a predetermined temporal change in the steering angle is detected by the steering angle sensor.

6. The method according to claim 5, wherein the monitoring of the operation of the steering handle only takes place after a predetermined time interval has elapsed after the activation of the assistance device.

7. The method according to claim 5, wherein the decoupling of the wheel steering angle from the steering angle is released during a predefined time interval, so that during this time interval a user intervention can also take place parallel to the intervention of the assistance device.

8. The method according to claim 5, wherein the decoupling is brought back linearly during the predefined time interval.

9. The method according to claim 5, wherein the decoupling is brought back exponentially during the predefined time interval.

10. A vehicle with an electromechanical steering system according to claim 1.

11. The electromechanical steering system according to claim 2, wherein the steering control device is configured to monitor the operation of the steering handle only after a predetermined time interval has elapsed after the activation of the assistance device.

12. The electromechanical steering system according to claim 2, wherein the steering control device is configured to reverse the decoupling of the wheel steering angle from the steering angle during a predefined time interval, so that during this time interval, parallel to the intervention of the assistance device, user intervention is also possible.

13. The electromechanical steering system according to claim 3, wherein the steering control device is configured to reverse the decoupling of the wheel steering angle from the steering angle during a predefined time interval, so that during this time interval, parallel to the intervention of the assistance device, user intervention is also possible.

14. The method according to claim 6, wherein the decoupling of the wheel steering angle from the steering angle is released during a predefined time interval, so that during this time interval a user intervention can also take place parallel to the intervention of the assistance device.

15. The method according to claim 6, wherein the decoupling is brought back linearly during the predefined time interval.

16. The method according to claim 7, wherein the decoupling is brought back linearly during the predefined time interval.

17. The method according to claim 6, wherein the decoupling is brought back exponentially during the predefined time interval.

18. The method according to claim 7, wherein the decoupling is brought back exponentially during the predefined time interval.
